(19) United States
(12) Patent Application Publication
(10) Pub. No.: US 2014/0346883 A1
(43) Pub. Date: Nov. 27, 2014

(54) CONTROL CIRCUIT FOR POWER SUPPLY

(71) Applicant: Hon Hai Precision Industry Co., Ltd., New Taipei (TW)

(72) Inventor: CHUN-PO CHEN, New Taipei (TW)

(73) Assignee: Hon Hai Precision Industry Co., Ltd., New Taipei (TW)

(21) Appl. No.: 14/285,747

(22) Filed: May 23, 2014

(30) Foreign Application Priority Data
May 23, 2013 (TW) 102118224

(51) Int. Cl. H02J 7/34

(52) U.S. Cl. CPC H02J 7/345
USPC 307/66

(57) ABSTRACT

A control circuit includes a controller, first and second electronic switches, a diode, first to fourth resistors, and a capacitor. The controller is coupled to a power supply of a computer. The controller is also coupled to the first and second electronic switches. The first electronic switch is coupled to a cathode of the diode through the second electronic switch. An anode of the diode is coupled to ground through the capacitor. When the mains supply operates normally, the capacitor is charged by the power supply. When the mains supply is cut off, the capacitor is discharged to provide voltages to the computer for data storage.

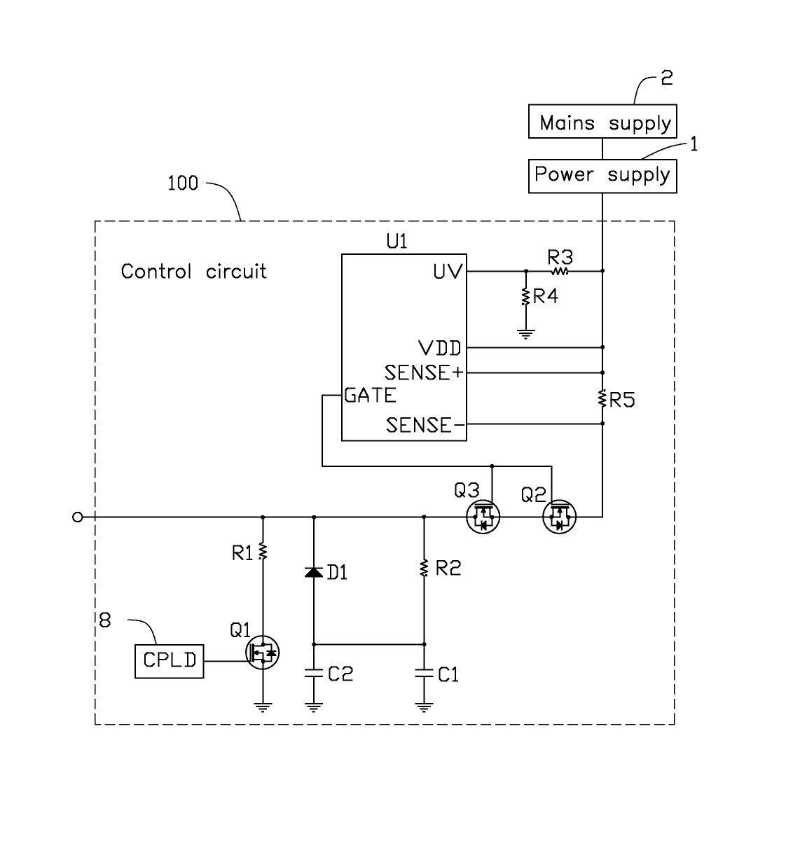

### FIELD

The subject matter herein generally relates to a control circuit for controlling a power supply unit to supply power for a computer.

### BACKGROUND

A computer requires a power supply to provide power to the computer.

### BRIEF DESCRIPTION OF THE DRAWING

Implementations of the present technology will now be described, by way of example only, with reference to the attached FIGURE.

The drawing is a circuit diagram of an embodiment of a control circuit for a power supply.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a control circuit to control a power supply. The power supply supplies power to a computer.

The drawing illustrates an embodiment of a control circuit 100 for controlling a power supply 1. The power supply 1 supplies power to a computer (not shown). The power supply 1 is coupled to a mains supply 2. In one embodiment, the power supply 1 can convert an alternating current (AC) from the mains supply 2 into direct current (DC). The control circuit 100 can comprise a controller U1, a diode D1, electronic switches Q1, Q2, and Q3, a complex programmable logic device (CPLD) 8, capacitors C1 and C2, and resistors R1-R5.

A monitor pin UV of the controller U1 is coupled to the power supply 1 through the resistor R3. The monitor pin UV of the controller U1 is coupled to ground through the resistor R4. A power pin VDD of the controller U1 is coupled to the power supply 1. A sensing pin SENSE+ of the controller U1 is coupled to the power supply 1. A sensing pin SENSE− of the controller U1 is coupled to the sensing pin SENSE+ of the controller U1 through the resistor R5. A control pin GATE of the controller U1 is coupled to a first terminal of the electronic switch Q2. A second terminal of the electronic switch Q2 is coupled to the sensing pin SENSE− of the controller U1. A first terminal of the electronic switch Q3 is coupled to the control pin GATE of the controller U1. A second terminal of the electronic switch Q3 is coupled to ground through the resistor R2 and the capacitor C1 in that order. A third terminal of the electronic switch Q3 is coupled to a third terminal of the electronic switch Q2.

A first terminal of the electronic switch Q1 is coupled to the CPLD 8. A second terminal of the electronic switch Q1 is coupled to the second terminal of the electronic switch Q3 through the resistor R1. A third terminal of the electronic switch Q1 is coupled to a ground. A cathode of the diode D1 is coupled to the second terminal of the electronic switch Q3. An anode of the diode D1 is coupled to ground through the capacitor C2. The anode of the diode D1 is also coupled to ground through the capacitor C1.

When the mains supply 2 operates normally, the control pin GATE of the controller U1 is at a high level in response to a divided voltage at the monitor pin UV of the controller U1 being greater than a preset voltage of the controller U1. The electronic switches Q2, Q3 are turned on when the first terminals of the electronic switches Q2, Q3 receive a high level signal from the control pin GATE. The power supply 1 supplies power to a computer through the electronic switches Q2 and Q3. At the same time, the CPLD 8 outputs a low level signal to the first terminal of the electronic switch Q1, thereby turning off the electronic switch Q1. Thus, the capacitors C1 and C2 can be charged by the power supply 1 through the resistor R2.

When the mains supply 2 is cut off, the control pin GATE of the controller U1 is at a low level in response to the divided voltage at the monitor pin UV of the controller U1 being less than the preset voltage of the controller U1. The electronic switches Q2, Q3 are turned off when the first terminals of the electronic switches Q2, Q3 receive a low level signal from the control pin GATE. Thus, the capacitors C1 and C2 can discharge to provide voltages to the computer through the diode D1 for data storage.

The CPLD 8 outputs a high-level signal to the first terminal of the electronic switch Q1 after the computer completes data storage, thereby turning on the electronic switch Q1. Thus, the capacitors C1 and C2 can fully discharge through the diode D1, the resistor R1, and the electronic switch Q1.

In at least one embodiment, the electronic switches Q1, Q2, and Q3 are n-channel field-effect transistors. The capacitors C1 and C2 are energy storage components for supplying power to the computer when the mains supply 2 is cut off.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A control circuit to control a power supply to supply power to a computer, the power supply coupled to a mains supply, the control circuit comprising:
a first resistor, a second resistor, a third resistor, a fourth resistor;
a diode;
an energy storage component;
a controller stored a preset voltage, the controller comprising a monitor pin, a power pin, a first sensing pin, a second sensing pin, and a control pin, wherein the monitor pin is coupled to the power supply through the first resistor and coupled to ground through the second resistor, the power pin is coupled to the power supply, the first sensing pin is coupled to the power supply and coupled to the second sensing pin through the third resistor; wherein the control pin is at a high level in response to a voltage at the monitor pin being greater than the preset voltage, and the control pin is at a low level in response to a voltage of the monitor pin being less than the preset voltage;
a first electronic switch comprising a first terminal coupled to the control pin of the controller, a second terminal coupled to the second sensing pin of the controller, and a third terminal; wherein the second terminal of the first electronic switch is coupled to the third terminal of the first electronic switch, in response to the first terminal of the first electronic switch receiving a high level signal; and the second terminal of the first electronic switch is disconnected from the third terminal of the first electronic switch, in response to the first terminal of the first electronic switch receiving a low level signal; and
a second electronic switch comprising a first terminal coupled to the control pin of the controller, a second terminal coupled to ground through the fourth resistor and the energy storage component in that order, and a third terminal coupled to the third terminal of the first electronic switch; wherein the second terminal of the second electronic switch is coupled to the third terminal of the second electronic switch, in response to the first terminal of the second electronic switch receiving a high level signal; and the second terminal of the second electronic switch is disconnected from the third terminal of the second electronic switch, in response to the first terminal of the second electronic switch receiving a low level signal.

2. The control circuit of claim 1, further comprising a complex programmable logic device (CPLD), a third electronic switch, and a fifth resistor, wherein a first terminal of the third electronic switch is coupled to the CPLD, a second terminal of the third electronic switch is coupled to the second terminal of the second electronic switch through the fifth resistor, a third terminal of the third electronic switch is coupled to a ground; the second terminal of the third electronic switch is disconnected from the third terminal of the third electronic switch when the mains supply operates normally; the second terminal of the third electronic switch is coupled to the third terminal of the third electronic switch after the computer has the data stored.

3. The control circuit of claim 2, wherein the third electronic switch is n-channel field effect transistor (FET), the first, second, and third terminals of the third electronic switch correspond to gate, source, and drain of the FET.

4. The control circuit of claim 1, wherein the energy storage component is a capacitor.

5. The control circuit of claim 1, wherein the first electronic switch and the second electronic switch are n-channel FETs, the first, second, and third terminals of the first and second electronic switches correspond to gates, sources, and drains of the FETs.
